(19) United States
(12) Patent Application Publication
(10) Pub. No.: US 2011/0235338 A1
(43) Pub. Date: Sep. 29, 2011

(54) LIGHT EMITTING DEVICE AND LENS THEREOF

(75) Inventors: Kuan-Hung Chen, Taipei (TW); Yu-Ju Liu, Taipei (TW)

(73) Assignee: EVERLIGHT ELECTRONICS CO., LTD., Taipei (TW)

(21) Appl. No.: 12/749,488

(22) Filed: Mar. 29, 2010

(51) Int. Cl. F21V 3/04; F21V 5/04; F21V 3/02

(52) U.S. Cl. 362/311.02; 362/335; 362/311.06

(57) ABSTRACT

A lens and a light emitting device applying the same are provided. The lens has a first profile along a first cross-section and a second profile along a second cross-section perpendicular to the first cross-section. The first profile is asymmetric with respect to the second cross-section, and the second profile is symmetric with respect to the first cross-section. A contour center of a light emergent surface of the lens is located on an intersection of the first cross-section and the second cross-section. The light emergent surface comprises a first curved surface and a second curved surface being connected with each other at the second cross-section. Furthermore, a curvature of the first curved surface and a curvature of the second curved surface are discontinuous at the contour center. The light emitting device applies the lens for receiving a light emitted from a light source and provides an asymmetric light output.

### BACKGROUND OF THE INVENTION

1. Field of the Invention

The present invention generally relates to a light emitting device and a lens thereof. More particularly, the present invention relates to a light emitting device and a lens applied thereto for providing an asymmetric light output.

2. Description of Related Art

Light emitting diodes (LEDs) have replaced fluorescent lamps and incandescent lamps in some fields, for example, lamps of scanners requiring for quick response, lamps of projection apparatus, backlight sources or front light sources of liquid crystal displays (LCDs), illumination for dashboards of automobiles, traffic lights, street lights, common illumination devices, etc. Compared with conventional lamps, the LEDs have absolute advantages, for example, small volume, long lifespan, low driving voltage/current, being non-fragile, mercury free (no pollution), and good luminous efficiency (power saving).

Since light emitting of an LED is omni-directional, front light emitting amount of the LED is limited. Accordingly, most manufactures try to improve the light emitting efficiency of the LED.

### SUMMARY OF THE INVENTION

Accordingly, the present invention is directed to a lens capable of collecting lights emitted from a light source and providing an asymmetric light output.

The present invention is directed to a light emitting device applying the aforementioned lens to improve the availability of light output.

As embodied and broadly described herein, the present invention provides a lens having a first profile along a first cross-section and a second profile along a second cross-section perpendicular to the first cross-section. The first profile is asymmetric with respect to the second cross-section, and the second profile is symmetric with respect to the first cross-section. A contour center of a light emergent surface of the lens is located on an intersection of the first cross-section and the second cross-section. The light emergent surface comprises a first curved surface and a second curved surface being connected with each other at the second cross-section. Furthermore, a curvature of the first curved surface and a curvature of the second curved surface are discontinuous at the contour center.

The present invention further provides a light emitting device applying the above lens for receiving a light emitted from a light source. The emitted light is incident into the lens and emerged from the light emergent surface.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a lens according to an embodiment of the present invention.

FIG. 2 is a top view of the lens of FIG. 1.

FIG. 3 show a profile of the lens along a cross-section A-A′ in FIG. 2.

FIG. 4 shows another profile of the lens along a cross-section B-B′ in FIG. 2.

FIG. 5 is a cross-sectional view of a light emitting device along the cross-section A-A′ according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

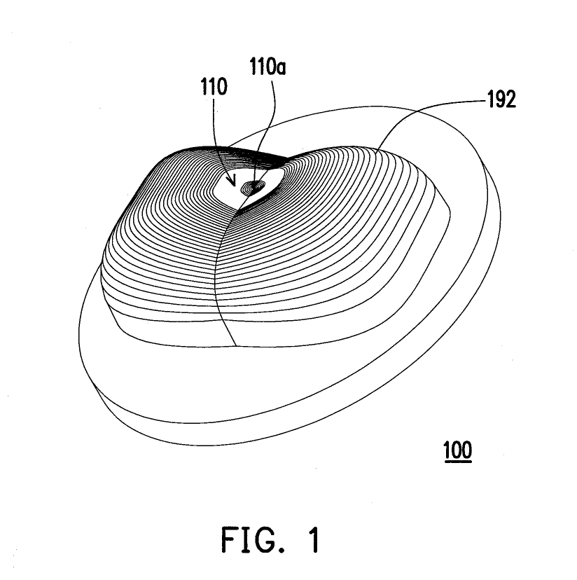

FIG. 1 illustrates a lens according to an embodiment of the present invention.

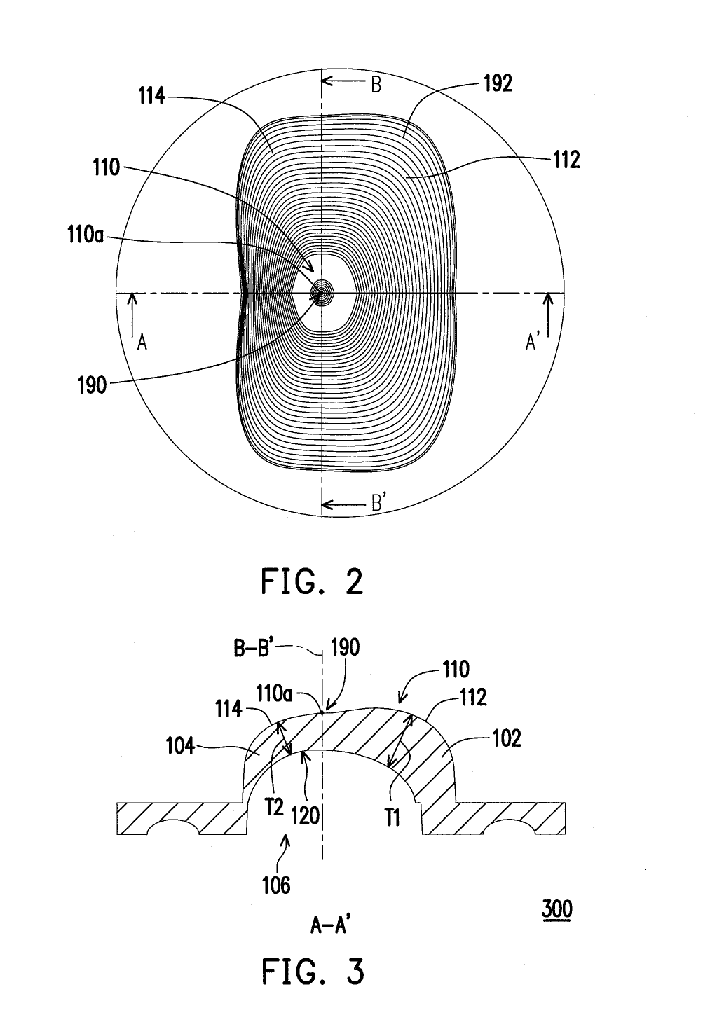

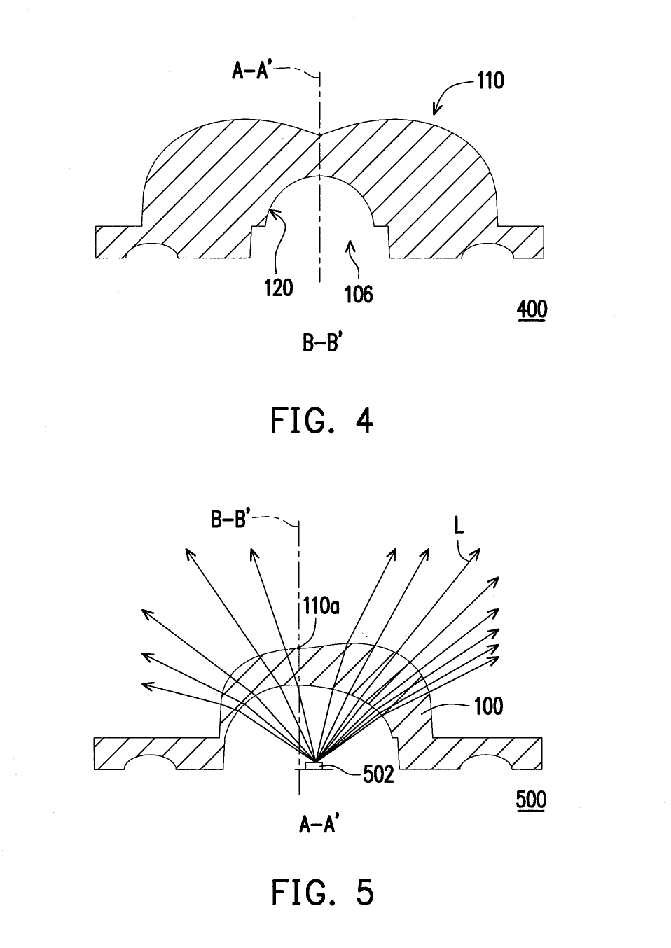

FIG. 2 is a top view of the lens of FIG. 1. Referring to FIGS. 1 and 2, a lens 100 is provided with a light emergent surface 110. A first profile 300 of the lens 100 along a cross-section A-A′ in FIG. 2 is illustrated in FIG. 3. Another second profile 400 of the lens 100 along a cross-section B-B′ in FIG. 2 is illustrated in FIG. 4. The cross-section A-A′ and the cross-section B-B′ are perpendicular to each other. As shown in FIG. 3, the first profile 300 of the lens 100 is asymmetric with respect to the cross-section B-B′; while as shown in FIG. 4, the second profile 400 is symmetric with respect to the cross-section A-A′.

Furthermore, the light emergent surface 110 has a contour center 110a, from which the contour of the light emergent surface 110 can be represented by a plurality of closed contour lines 192 as shown in FIGS. 1 and 2. In the present embodiment, the contour center 110a of the light emergent surface 110 is located on an intersection 190 of the cross-section A-A′ and the cross-section B-B′. Specifically, the light emergent surface 110 can be divided into a first curved surface 112 and a second curved surface 114 by the cross-section B-B′, wherein a curvature of the first curved surface 112 and a curvature of the second curved surface 114 are discontinuous at the contour center 110a.

In addition, referring to FIGS. 3 and 4, the lens 100 further has a light incident surface 120 which is concaved to form a space 106 for accommodating a light source and receiving a light emitted from the light source. Furthermore, as shown in FIGS. 2 and 3, the lens 100 can be divided by the cross-section B-B′ into a first part 102 and a second part 104, wherein the first part 102 and the second part 104 are asymmetric with respect to the cross-section B-B′, and a lens thickness T1 of the first part 102 is greater than a lens thickness T2 of the second part 104.

The aforementioned lens 100 may be accompanied with a light source to form a light emitting device. FIG. 5 is a cross-sectional view of a light emitting device along the cross-section A-A′ according to an embodiment of the present invention. Referring to FIG. 5, the light emitting device 500 comprises a light source 502 and the lens 100 as mentioned in the above embodiment. Herein, the light source 502 may be a light emitting diode or other applicable light sources.

FIG. 5 further shows transmission path of lights L emitted from the light source 502. Referring to FIGS. 3 and 5, the lights L from the light source 502 are incident into the lens 100 through the light incident surface 120 and emerged from the light emergent surface 110. Since the lens 100 has an asymmetric profile in cross-section A-A′, intensity of lights L emerged from the light emergent surface 110 in a specific direction can be adjusted. Specifically, in the present embodiment, the lens thickness T1 of the first part 102 is greater than the lens thickness T2 of the second part 104. The average curvature of the light emergent surface 110 of the first part 102 is greater than the average curvature of the light emergent surface 110 of the second part 104. Owing to the curvature design of the light emergent surface 110 of the first part 102, the luminance uniformity is improved and the lighting area is enlarged. Accordingly, the light output from the first part 102 can be enhanced by the illustrated contour in FIGS. 3 and 5.

Furthermore, the position of the light source 502 relative to the lens 100 is not restricted and can be changed for adjusting the profile of light output. As shown in FIGS. 3 and 5, the light source 502 may be located on the cross-section A-A′ and depart from the intersection 190 of the cross-section A-A′ and the cross-section B-B′. More preferably, the light source 502 can be arranged at the same side of the cross-section B-B′ with the first part 102 of the lens 100, to provide more lights incident into the first part 102 and thereby enhance the light output from the first part 102.

In summary, the present invention provides a lens having an asymmetric profile for receiving an omni-directional light source and adjusting intensity of light output in a specific direction to provide an asymmetric light output. The profile of light output can be adjusted by changing the position of the light source relative to the lens and varying the profile of the lens, such as the contour of the light emergent surface and the light incident surface, and the lens thickness, etc. By utilizing the asymmetric lens, the profile of light output of the light emitting device can be adjusted and the availability of light output can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lens having a first profile along a first cross-section and a second profile along a second cross-section perpendicular to the first cross-section, wherein the first profile is asymmetric with respect to the second cross-section, the second profile is symmetric with respect to the first cross-section, a contour center of a light emergent surface of the lens is located on an intersection of the first cross-section and the second cross-section, the light emergent surface comprises a first curved surface and a second curved surface being connected with each other at the second cross-section, and a curvature of the first curved surface and a curvature of the second curved surface are discontinuous at the contour center.

2. The lens according to claim 1, wherein the lens comprises a first part and a second part defined by the second cross-section and being asymmetric with respect to the second cross-section, and a lens thickness of the first part is greater than a lens thickness of the second part.

3. The lens according to claim 1, wherein the lens further has a light incident surface which is concaved for accommodating a light source and receiving a light emitted from the light source.

4. A light emitting device, comprising:
a lens having a first profile along a first cross-section and a second profile along a second cross-section perpendicular to the first cross-section, wherein the first profile is asymmetric with respect to the second cross-section, the second profile is symmetric with respect to the first cross-section, a contour center of a light emergent surface of the lens is located on an intersection of the first cross-section and the second cross-section, the light emergent surface comprises a first curved surface and a second curved surface being connected with each other at the first cross-section, and a curvature of the first curved surface and a curvature of the second curved surface are discontinuous at the contour center; and
a light source emitting a light incident into the lens and emerged from the light emergent surface.

5. The light emitting device according to claim 4, wherein the lens has a light incident surface for receiving the emitted light and being concaved for accommodating the light source.

6. The light emitting device according to claim 4, wherein the light source is located at the first cross-section but departing from the intersection of the first cross-section and the second cross-section.

7. The light emitting device according to claim 4, wherein the lens comprises a first part and a second part divided by the second cross-section and being asymmetric with respect to the second cross-section, and a lens thickness of the first part is greater than a lens thickness of the second part.

8. The light emitting device according to claim 7, wherein both of the light source and the first part of the lens are located at the same side of the second cross-section.

9. The light emitting device according to claim 4, wherein the light source comprises a light emitting diode.
